(19) United States
(12) Patent Application Publication
(10) Pub. No.: US 2018/0276912 A1
(43) Pub. Date: Sep. 27, 2018

(54) Machine Learning for Triaging Failures in Autonomous Vehicles

(71) Applicant: Uber Technologies, Inc., San Francisco, CA (US)

(72) Inventor: Xinyu Zhou, Greensburg, PA (US)

(21) Appl. No.: 15/467,504

(22) Filed: Mar. 23, 2017

(51) Int. Cl. G07C 5/08

(52) U.S. Cl. CPC G07C 5/0808; G07C 5/085

(57) ABSTRACT

The present disclosure provides systems and methods for automatic triaging of failure events experienced by autonomous vehicles. In particular, the systems and methods of the present disclosure can include or otherwise leverage one or more machine learned classifier models that can perform failure type classification on the basis of various features extracted from vehicle data that is descriptive of conditions experienced by an autonomous vehicle at the time of one or more vehicle failure events. In addition, existing vehicle data logs that include failure type labels manually applied by a human reviewer can be used to train the machine learned classifier model.

### FIELD

The present disclosure relates generally to autonomous vehicles. More particularly, the present disclosure relates to triaging failures experienced by autonomous vehicles through the use of machine learned classifier models and to training techniques for such classifier models.

### BACKGROUND

An autonomous vehicle is a vehicle that is capable of sensing its environment and navigating with minimal or no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to triage failures experienced by autonomous vehicles. The method includes obtaining, by one or more computing devices, vehicle data descriptive of vehicle conditions associated with an autonomous vehicle during one or more autonomous driving sessions. The one or more autonomous driving sessions include one or more vehicle failure events. The method includes extracting, by the one or more computing devices, a plurality of features from the vehicle data for each of the one or more vehicle failure events. The method includes determining, by the one or more computing devices using a machine-learned classifier, a failure type classification for each of one or more vehicle failure events based at least in part on the plurality of features that are respectively associated with the one or more vehicle failure events. The method includes associating, by the one or more computing devices, the failure type classification determined for each of the one or more vehicle failure events with the vehicle data.

Another example aspect of the present disclosure is directed to a computer system. The computer system one or more processors and one or more tangible, non-transitory, computer-readable media that collectively store at least one vehicle data log that was collected during a previous autonomous vehicle driving session. The vehicle data log is descriptive of vehicle conditions associated with an autonomous vehicle during the previous autonomous vehicle driving session. The vehicle data log is annotated with one or more failure type labels respectively at one or more times that correspond to one or more vehicle failure events. The one or more failure type labels were provided by a human reviewer of the at least one vehicle data log. The one or more tangible, non-transitory computer-readable media also collectively store instructions that, when executed by the one or more processors, cause the computer system to: extract, for each of the one or more times, one or more features from the vehicle data log; associate each failure type label with the one or more features extracted from the vehicle data log for the corresponding time; and train a classifier model to perform failure type classification based at least in part on the one or more failure type labels and the one or more features respectively associated therewith.

Another example aspect of the present disclosure is directed to a computer system. The computer system includes one or more processors. The computer system includes a machine-learned classifier model. The computer system includes one or more tangible, non-transitory, computer-readable media that store instructions that, when executed by the one or more processors, cause the one or more processors perform operations. The operations include obtaining vehicle data descriptive of vehicle conditions associated with an autonomous vehicle during a driving session. The operations include extracting a plurality of features from the vehicle data. The operations include identifying one or more vehicle failure events. The operations include inputting, for each of the one or more vehicle failure events, the plurality of features into the machine-learned classifier model. The operations include receiving, for each of the one or more vehicle failure events, a failure type classification for the vehicle failure event as an output of the machine-learned classifier model. The operations include associating the failure type classification provided for each of the one or more vehicle failure events with the vehicle data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example training configuration according to example embodiments of the present disclosure.

FIG. 2 depicts a block diagram of an example processing pipeline for failure type classification according to example embodiments of the present disclosure.

FIG. 3 depicts a block diagram of an example computing system according to example embodiments of the present disclosure.

FIG. 4 depicts a flowchart diagram of an example method for failure type classification according to example embodiments of the present disclosure.

FIG. 5 depicts a flowchart diagram of an example method for training a classifier model according to example embodiments of the present disclosure.

FIG. 6 depicts a flowchart diagram of an example method for disambiguating isolated vehicle failures from whole-fleet failures according to example embodiments of the present disclosure.

FIG. 7 depicts a flowchart diagram of an example method for disambiguating isolated vehicle failures from whole-fleet failures according to example embodiments of the present disclosure.

### DETAILED DESCRIPTION

Generally, the present disclosure is directed to systems and methods for automatic triaging of failure events experienced by autonomous vehicles. In particular, the systems and methods of the present disclosure can include or otherwise leverage one or more machine learned classifier models that can perform failure type classification on the basis of various features extracted from vehicle data that is descriptive of conditions experienced by an autonomous vehicle at the time of one or more vehicle failure events. As one example, vehicle failure events can include instances in which a human operator was required to assume manual control of the autonomous vehicle. Thus, a classifier model can receive the features extracted from the vehicle data and, in response, can output a failure type classification for a vehicle failure event. For example, the failure type classification can specify which of a plurality of autonomous vehicle control systems was responsible for such vehicle failure event. As a result, for example, the classified vehicle failure event can be triaged or otherwise routed to the appropriate development team for analysis and resolution. According to another aspect of the present disclosure, existing vehicle data logs that include failure type labels manually applied by a human reviewer can be used to train the machine learned classifier model. For example, the classifier model can be trained using an objective function that describes a difference between failure type classifications predicted by the classifier model on the existing vehicle data log and the corresponding failure type labels provided by the human reviewer for the vehicle data log.

More particularly, one aspect of developing, operating, and refining autonomous vehicle technology is continuously testing and evaluating the performance of autonomous vehicles. As an example, during operation of an autonomous vehicle to perform an autonomous driving session, the autonomous vehicle can experience one or more vehicle failure events. As one example, vehicle failure events can include instances in which a human operator was required to assume manual control of the autonomous vehicle. For example, the autonomous vehicle may have been unable to determine an appropriate motion path through its environment and, therefore, came to a stop or otherwise became “frozen.” As another example, vehicle failure events can include instances in which the autonomous vehicle collided with an object or nearly collided with an object. As yet another example, vehicle failure events can include instances in which the autonomous vehicle performed a driving maneuver that was uncomfortable for a human passenger or otherwise undesirable. Thus, as used herein, the term “failure events” does not necessarily correspond to or require instances in which the autonomous vehicle was unable to operate at all or collided or nearly collided with another object, but instead more generally refers to any instance in which the autonomous vehicle operated in a fashion that was undesirable for some reason, including, for example, passenger comfort, human safety, vehicle efficiency, and/or other objectives. Thus, a failure event can include any notable incident, such as an incident that has an impact on ride quality even if no part of the autonomous vehicle control system actually failed. In each instance of a vehicle failure event, a timestamp of such failure event can be recorded or otherwise associated with vehicle data that was collected and stored by the autonomous vehicle contemporaneous to the time of such failure event.

Diagnosing and resolving such vehicle failure events can assist in ensuring that such vehicle failure events do not reoccur and, more generally, improving the autonomous vehicle technology as a whole. One aspect of diagnosing and resolving vehicle failure events is to identify which of a number of vehicle control systems is most likely responsible for the vehicle failure event occurring.

As an example, in some implementations, an autonomous vehicle computing system can include a perception system, a prediction system, a motion planning system, and/or other components or systems that cooperate to perceive the surrounding environment of the autonomous vehicle and determine a motion plan for controlling the motion of the autonomous vehicle accordingly. For example, the perception system can receive sensor data from one or more sensors (e.g., light detection and ranging sensors, radio detection and ranging sensors, cameras, etc.) that are coupled to or otherwise included within the autonomous vehicle. The perception system can identify one or more objects that are proximate to the autonomous vehicle based on the sensor data. The prediction system can receive object information from the perception system and can predict one or more future locations for each object based on the information received from the perception system. The motion planning system can determine a motion plan for the autonomous vehicle based at least in part on the predicted one or more future locations for the objects. Stated differently, given information about the current locations of objects and/or predicted future locations of proximate objects, the motion planning system can determine a motion plan for the autonomous vehicle that best navigates the autonomous vehicle relative to the objects at such locations. The autonomous vehicle can also include other systems and/or components including, for example, a localization system that determines a current location and/or pose of the autonomous vehicle. For example, as used herein, the “pose” of a vehicle can refer to the position of the vehicle in the real world. The autonomous vehicle can further include various hardware and/or firmware components that perform various functions or implement various systems described above.

Thus, an autonomous vehicle can include a number of systems or components, examples of which are provided above. A vehicle failure event can be attributable to one or more of such systems or components. As such, identifying which system or component is responsible for the vehicle failure event is an important aspect of diagnosing and resolving vehicle failure events. For example, once a particular system or component has been identified, the vehicle failure event can be routed to the development team that is responsible for developing and/or maintaining the system identified as responsible for the vehicle failure event. For example, a ticket can be generated for the vehicle failure event and assigned to the appropriate development team for analysis and resolution.

One potential technique by which a system or component that is responsible for the vehicle failure can be identified is to have a human manually review the vehicle data and attempt to manually determine or identify which system or component is responsible for the vehicle failure. For example, a human reviewer can use a review tool to, for example, view a screenshot of the environment as observed by the autonomous vehicle at the time of a vehicle failure event; watch a playback of vehicle data collected around the time of the vehicle failure event; watch a playforward simulation of a simulated continuation of the vehicle if manual control of the vehicle had not been assumed; view a map; or other review actions. For example, the playback and/or the playforward tools can provide visualizations of sensor data such as, for example, visualizations of light detection and ranging data, radio detection and ranging data, imagery captured by the autonomous vehicle, etc.

Upon reviewing the vehicle data via the review tool, the human reviewer can assign a failure type label to the failure event. In particular, in some implementations, the failure type label provided by the human reviewer for each vehicle failure event can describe the reviewer's estimate of which vehicle system or component was responsible for such vehicle failure event. The failure type label can be associated with the vehicle failure event and/or the vehicle data that was collected and stored by the autonomous vehicle contemporaneous to the vehicle failure event.

However, the above technique that relies upon human reviewers to triage vehicle failure events has a number of drawbacks. As examples, the use of human reviewers causes such technique to be high cost and challenging to scale. In addition, use of different human reviewers relies on different judgments of which failure type labels to apply, rather than a uniform judgment, which can result in poor and/or inconsistent classification of vehicle failure events.

In view of the above, the present disclosure provides systems and methods for automatic triaging of failure events experienced by autonomous vehicles. In particular, the systems and methods of the present disclosure can include or otherwise leverage one or more machine learned classifier models that can perform failure type classification on the basis of various features extracted from vehicle data that is descriptive of conditions experienced by an autonomous vehicle at the time of one or more vehicle failure events. For example, the classifier model can provide a failure type classification that specifies which of a plurality of autonomous vehicle control systems was responsible for such vehicle failure event. As a result, for example, the classified vehicle failure event can be triaged or otherwise routed to the appropriate development team for analysis and resolution. According to another aspect of the present disclosure, existing vehicle data logs that include failure type labels manually recorded by a human reviewer can be used to train the machine learned classifier model. For example, the classifier model can be trained using an objective function that describes a difference between failure type classifications predicted by the classifier model on the existing vehicle data log and the failure type labels provided by the human reviewer for the vehicle data log.

Once the classifier model has been trained, the systems and methods of the present disclosure can assist in triaging vehicle failure events completely based on sensor feedbacks and/or other vehicle data, thereby eliminating the need for human reviewers to manually review vehicle failure events. In addition, the systems and methods of the present disclosure can provide more consistent and accurate results than human reviewers and, further, can be applied to both real world vehicle data and simulated vehicle data. As such, the systems and methods of the present disclosure can be applied in a number of scenarios, including, as examples: classifying vehicle failure events associated with previous vehicle data logs from previously performed autonomous driving sessions; classifying vehicle failure events from vehicle data in real-time (e.g., for failure response management by an overseer and/or for displaying recommended classifications for selection by a human passenger of the vehicle); classifying simulated vehicle failure events associated with simulated vehicle data; and/or other scenarios which will be discussed in more detail below.

More particularly, the systems and methods of the present disclosure can perform automatic classification of vehicle failure events for an autonomous vehicle based on vehicle data associated with the autonomous vehicle. For example, the vehicle data can be descriptive of vehicle conditions associated with an autonomous vehicle during an autonomous driving session. In some implementations, the vehicle data can include data collected by or otherwise received from various sensors included in the autonomous vehicle. As examples, the vehicle data can include data descriptive of a speed (also referred to as velocity), a steering angle, an acceleration, a braking amount, a vehicle class, operation of an adaptive cruise control system, or any other conditions or operating parameters associated with the autonomous vehicle. As further examples, the vehicle data can include various other types of data descriptive of vehicle conditions, including, for example: light detection and ranging data; radio detection and ranging data; imagery collected by one or more cameras onboard the autonomous vehicle; accelerometer data; positioning system data; gyroscope data; throttle position data; engine or crankshaft torque data; exhaust oxygen data; engine air flow data; engine RPM data; vehicle control data associated with a vehicle controller; and/or any other form of vehicle data associated with the vehicle (e.g., collected or produced by sensors or systems onboard the vehicle). As indicated above, the systems and methods of the present disclosure can perform classification of vehicle failure events based on such vehicle data.

In some implementations of the present disclosure, the vehicle data can include vehicle data logs from completed driving sessions. For example, an autonomous vehicle or associated computing system can collect and store vehicle data as the autonomous vehicle executes a driving session. After the session has been completed, a log of the vehicle data can be transferred to a computing system that performs classification of vehicle failure events that occurred during the corresponding driving session according to the techniques described herein. As another example, in some implementations of the present disclosure, the vehicle data can be received and analyzed in real-time as the autonomous vehicle operates. For example, in some implementations, the failure classification systems of the present disclosure can be located physically onboard the autonomous vehicle and can receive the vehicle data and classify vehicle failure events in real-time as they occur. As yet another example, in some implementations, the vehicle data can include simulated vehicle data.

According to another aspect of the present disclosure, the systems of the present disclosure can include a feature extractor that extracts a plurality of features from the vehicle data. In some implementations, the feature extractor can extract the plurality of features from the vehicle data for each of one or more times at which one or more vehicle failure events respectively occurred. In other implementations, the feature extractor can continuously or near-continuously sample the vehicle data or can sample according to an even or uneven periodicity. In some implementations, each sample of the vehicle data can include a window of data around a particular sampling time.

Regardless, for each instance of sampling of the vehicle data or other classification actions, the feature extractor can extract one or more features from the vehicle data. Generally, the features can be of any type that is useful for classifying vehicle failure events. Example features that can be extracted from the vehicle data include the following example features: a valid pose feature indicative of whether a pose of the autonomous vehicle was valid at the time of the vehicle failure event; a cost vendor feature indicative of a vendor of a largest cost associated with a motion plan of the autonomous vehicle at the time of the vehicle failure event; a pre-failure stop reason feature indicative of a first reason that caused the autonomous vehicle to stop prior to the time of the vehicle failure event; a post-failure stop reason feature indicative of a second reason that caused the autonomous vehicle to stop after the time of the vehicle failure event; a failure stop reason indicative of a third reason that caused the autonomous vehicle to stop before and after the time of the vehicle failure event; one or more acceleration features indicative of an acceleration of the autonomous vehicle at one or more times surrounding the time of the vehicle failure event; one or more velocity features indicative of a velocity of the autonomous vehicle at one or more times surrounding the time of the vehicle failure event; a velocity difference feature indicative of a difference in the velocity of the autonomous vehicle before and after the time of the vehicle failure event; a map valid feature indicative of whether a map used by the autonomous vehicle was valid at the time of the vehicle failure event; an unprotected turn distance to stop line feature indicative of a distance to a stop line during an unprotected turn; a wheel angle feature indicative of an angle of one or more wheels of the autonomous vehicle at the time of the vehicle failure event; an odometer difference feature indicative of a distance traveled by the autonomous vehicle after the time of the vehicle failure event; a stopping pose feature indicative of whether a stopping pose of the autonomous vehicle was set at the time of the vehicle failure event; a stopping distance feature indicative of a distance between the autonomous vehicle and the stop line; an adaptive cruise control active feature indicative of whether an adaptive cruise control system of the autonomous vehicle was operating at the time of the vehicle failure event; an adaptive cruise control velocity feature indicative of a velocity of a vehicle tracked by the adaptive cruise control system of the autonomous vehicle at the time of the vehicle failure event; an adaptive cruise control pre-change feature indicative of a number of times the vehicle tracked by the adaptive cruise control system of the autonomous vehicle changed prior to the time of the vehicle failure event; an adaptive cruise control post-change feature indicative of whether the vehicle tracked by the adaptive cruise control system of the autonomous vehicle changed after the time of the vehicle failure event; an adaptive cruise control disappear feature indicative of whether the vehicle tracked by the adaptive cruise control system of the autonomous vehicle disappeared; a stopped feature indicative of whether the autonomous vehicle was stopped at the time of the vehicle failure event; a total cost feature indicative of a total cost associated with the motion plan of the autonomous vehicle at the time of the vehicle failure event; a brake torque feature indicative of a brake torque value of the autonomous vehicle at the time of the vehicle failure event; a left turn signal feature indicative of whether a left turn signal of the autonomous vehicle was illuminated at the time of the vehicle failure event; a right turn signal feature indicative of whether a right turn signal of the autonomous vehicle was illuminated at the time of the vehicle failure event; a rolling back feature indicative of whether the autonomous vehicle was rolling backwards at the time of the vehicle failure event; a juke feature indicative of whether the autonomous vehicle was performing a juke event at the time of the vehicle failure event; a spurious point feature indicative of a number of spurious points associated with the autonomous vehicle at the time of the vehicle failure event; a temperature feature indicative of a temperature at the time of the vehicle failure event; a time of day feature indicative of a time of day at the time of the vehicle failure event; a wiper feature indicative of whether one or more wipers of the autonomous vehicle were operating at the time of the vehicle failure event; a headlight feature indicative of whether one or more headlights of the autonomous vehicle were illuminated at the time of the vehicle failure event; a nearest untrustworthy object feature indicative of a distance to a nearest object designated as untrustworthy; and a weather feature indicative of weather experienced by the autonomous vehicle at the time of the vehicle failure event. In some implementations, the features can further include notations (e.g., in the form of hashtags, one or more characters, etc.) that were provided by a human passenger of the autonomous vehicle. For example, the notations provided by human passengers can provide a sense or description of what the human passenger experienced during the vehicle failure event (e.g., “#hardbrake”). In other implementations, notations provided by human passengers are not included in the features. The above features are provided as examples only. Many other and different features can be extracted by the feature extractor and used by the classifier model to classify a vehicle failure event.

The features extracted for a particular time sample of the vehicle data (e.g., a time sample that corresponds to a vehicle failure event) can be input into a machine learned classifier model to receive a failure type classification for the corresponding vehicle failure event. For example, the classifier model can receive the features for a given time sample and, in response, provide the failure type classification based on the received features for such time sample or corresponding vehicle failure event. In some implementations, the raw vehicle data can also be provided as inputs to the classifier model in addition to the extracted features. The classification can be a binary classification (e.g., identify a single classification) or a multinomial classification (e.g., provide a relative score or probability for each available classification). Example failure type classifications include: a prediction classification; a perception classification; a motion planning classification; a hardware and firmware classification; a localization classification; an “other” classification; and/or any other types of classification that are desired to be detected. The classification can be used to route the vehicle failure event to the appropriate development team. In some implementations, classifications that are provided with low probability and/or low confidence can be marked as unknown and assessed manually.

As examples, the machine-learned model can be or include one or more of: a random forest classifier; a logistic regression classifier; a support vector machine; one or more decision trees; a neural network; a k-nearest neighbors model; and/or other types of models including both linear models and non-linear models. Neural networks can include deep neural networks, feed-forward neural networks, recurrent neural networks (e.g., long short-term memory recurrent neural networks), convolutional neural networks, or combinations thereof. Various models described above can be boosted using Adaptive Boosting, Gradient Boosting, or other techniques.

According to another aspect of the present disclosure, existing vehicle data logs that include failure type labels assigned by a human reviewer can be used to train the machine learned classifier model. In particular, as described above, a human reviewer can review the available vehicle data associated with a vehicle failure event and can manually assign a failure type label for the vehicle failure event. The humanly-assigned failure type label can be attached to the data collected by the autonomous vehicle at the time of the vehicle failure event. Thus, although generally inefficient for the reasons discussed above, use of a human reviewer to provide manual failure type labels can result in a corpus of vehicle data logs that include failure type labels that are associated with vehicle failure events and corresponding vehicle data. According to an aspect of the present disclosure, such corpus of vehicle data logs with failure type labels can be used to train the machine learned classifier model.

In some implementations, to generate training data from the vehicle data logs and manual failure type labels, the systems and methods of the present disclosure can extract, for each time at which a failure type label has been applied to the vehicle data, one or more features from the vehicle data log. For example, the feature extraction process described above can be applied at each instance in which a label has applied to the vehicle data. The failure type label can then be associated with the one or more features extracted from the vehicle data log for the corresponding time or vice versa. Thus, as a result, a training set can be generated that includes a plurality of sets of features, where each set of features is labeled with a particular failure type label (e.g., “perception system”).

The classifier model can be trained using such training data. In particular, in some implementations, a training computing system can, for each pair of extracted features and corresponding failure type label, input the extracted features into the classifier model; receive at least one failure type classification as an output of the classifier model; and evaluate an objective function that describes a difference between the at least one failure type classification and the failure type label that corresponds to the input features. The training system can train the classifier model based at least in part on the objective function. As one example, in some implementations, the objective function can be backpropagated through the classifier model to train the classifier model. In such fashion, the classifier model can be trained to provide a correct failure type classification based on the receipt of features extracted from vehicle data.

Once the classifier model has been trained, the systems and methods of the present disclosure can assist in triaging vehicle failure events completely based on sensor feedbacks and/or other vehicle data, thereby eliminating the need for human reviewers to manually review vehicle failure events. Thus, as one technical benefit, the machine learning-based systems of the present disclosure can greatly reduce the cost associated with evaluating and testing autonomous vehicle ride quality, as human reviewers are not required. In addition, the machine learning-based systems of the present disclosure can easily be scaled to thousands of autonomous vehicles, which is in contrast to the inability to directly scale human reviewers for vehicle failure event analysis. Likewise, the use of machine learned models enables failure type classifications to be rendered at an extremely high rate (e.g., 1 second per triage).

As another technical benefit, the systems and methods of the present disclosure can provide more consistent and accurate results than human reviewers. In particular, instead of relying on inconsistent judgments of which failure type label is appropriate, a single model or set of models can be used across all instances of failure classification to perform consistent vehicle failure type classification. Likewise, in some implementations, the classifier model can be a reusable component that is able to assist in performing triage in a number of different scenarios or workflows.

As a further technical benefit, the systems and methods of the present disclosure can be applied to both real world vehicle data and simulated vehicle data. As significant amounts of autonomous vehicle testing and development can be performed within a simulated space, the ability to perform event classification on simulated vehicle data enables enhanced techniques for technological development. Improvements in autonomous vehicle technology that are enabled by the present disclosure can enhance ride quality, passenger comfort, and general vehicle performance.

According to yet further aspects of the present disclosure, in some implementations, the systems and methods described herein can be used to disambiguate vehicle failure events that are isolated to a single autonomous vehicle versus vehicle failure events that are attributable to systems or components that are common across all autonomous vehicles included in a fleet. As one example, after a first vehicle failure event experienced by a first autonomous vehicle at a location has been classified, a second autonomous vehicle can be directed to the location. In particular, the second autonomous vehicle can attempt to recreate a similar driving scenario as to that which resulted in the first vehicle failure event experienced by the first autonomous vehicle (e.g., the second vehicle can follow a same motion path as the first vehicle). Vehicle data collected by the second autonomous vehicle at the location can be classified using the classifier model. If a different failure type classification is provided for the vehicle data from the second autonomous vehicle relative to the first autonomous vehicle (e.g., the same failure type is not experienced by the second vehicle), then it can be assumed that the issue that led to the first vehicle failure event is isolated to the first autonomous vehicle and, as a result, the first autonomous vehicle can be recalled to a service center for testing and/or maintenance.

However, if the same failure type classification is provided for the vehicle data from the second autonomous vehicle relative to the first autonomous vehicle (e.g., the same failure type is experienced by the second vehicle), then it can be assumed that the issue that led to the first vehicle failure event is not isolated to the first autonomous vehicle and, as a result, the autonomous control system that corresponds to the failure type requires further maintenance across all vehicles in the fleet. In some instances, a same failure type by multiple vehicles at the same location can indicate that there is an error in the corresponding map data for such location or insufficient map data for such location. For example, a newly installed stop sign may not be included in the map data. To resolve this issue, for example, the location can temporarily be marked as non-accessible for autonomous vehicles and a mapping vehicle can be directed to the location to collect additional/updated map data for such location.

In another example, after the first vehicle failure event experienced by the first autonomous vehicle at the location has been classified, a simulation system can generate simulated vehicle data for the autonomous vehicle that corresponds to a simulation a portion of a real world autonomous driving session that included the first vehicle failure event. The simulated vehicle data can be classified using the classifier model. If a different failure type classification is provided for the simulated vehicle data (e.g., the same failure type is not experienced in the simulation), then it can be assumed that the issue that led to the first vehicle failure event is isolated to the first autonomous vehicle and, as a result, the first autonomous vehicle can be recalled to a service center for testing and/or maintenance. However, if the same failure type classification is provided for the simulated vehicle data relative to the first autonomous vehicle (e.g., the same failure type is experienced during the simulation), then it can be assumed that the issue that led to the first vehicle failure event is not isolated to the first autonomous vehicle and, as a result, the autonomous control system that corresponds to the failure type requires further maintenance across all vehicles in the fleet. In some instances, a same failure type in both real vehicle data and simulated vehicle data can indicate that there is an error in the map data for the corresponding location or insufficient map data for such location. To resolve this issue, for example, the location can temporarily be marked as non-accessible for autonomous vehicles and a mapping vehicle can be directed to the location to collect additional/updated map data for such location.

With reference now to the Figures, example embodiments of the present disclosure will be discussed in further detail.

### Example Devices and Systems

FIG. 1 depicts a block diagram of an example training configuration according to example embodiments of the present disclosure. The example training configuration of FIG. 1 includes a feature extractor 106 and a classifier model 110.

More particularly, according to another aspect of the present disclosure, existing vehicle data logs 203 that include failure type labels assigned by a human reviewer can be used to train a machine learned classifier model 110. In particular, as described above, a human reviewer can review the available vehicle data associated with a vehicle failure event and can manually assign a failure type label for the vehicle failure event. The humanly-assigned failure type label can be attached to the data collected by the autonomous vehicle at the time of the vehicle failure event. Thus, although generally inefficient for the reasons discussed above, use of a human reviewer to provide manual failure type labels can result in a corpus of vehicle data logs 203 that include failure type labels that are associated with vehicle failure events and corresponding vehicle data. According to an aspect of the present disclosure, such corpus of vehicle data logs 203 with failure type labels can be used to train the machine learned classifier model 110.

In some implementations, to generate training data from the vehicle data logs 203 and manual failure type labels, the systems and methods of the present disclosure can extract, for each time at which a failure type label has been applied to the vehicle data 203, one or more features from the vehicle data log 203. For example, the feature extractor 106 can be applied at each instance in which a label has applied to the vehicle data 203. The failure type label can then be associated with the one or more features extracted from the vehicle data log 203 for the corresponding time or vice versa. Thus, as a result, a training set can be generated that includes a plurality of sets of features, where each set of features is labeled with a particular failure type label (e.g., “perception system”).

The classifier model 110 can be trained using such training data. In particular, in some implementations, a training computing system can, for each pair of extracted features and corresponding failure type label, input the extracted features into the classifier model 110; receive at least one failure type classification 111 as an output of the classifier model 110; and evaluate an objective function 212 that describes a difference between the at least one failure type classification 111 and the failure type label that corresponds to the input features. The training system can train the classifier model 110 based at least in part on the objective function 212. As one example, in some implementations, the objective function 212 can be backpropagated through the classifier model 110 to train the classifier model 110. In such fashion, the classifier model 110 can be trained to provide a correct failure type classification 111 based on the receipt of features extracted from vehicle data 203.

Once the classifier model 110 has been trained, the systems and methods of the present disclosure can assist in triaging vehicle failure events completely based on sensor feedbacks and/or other vehicle data, thereby eliminating the need for human reviewers to manually review vehicle failure events.

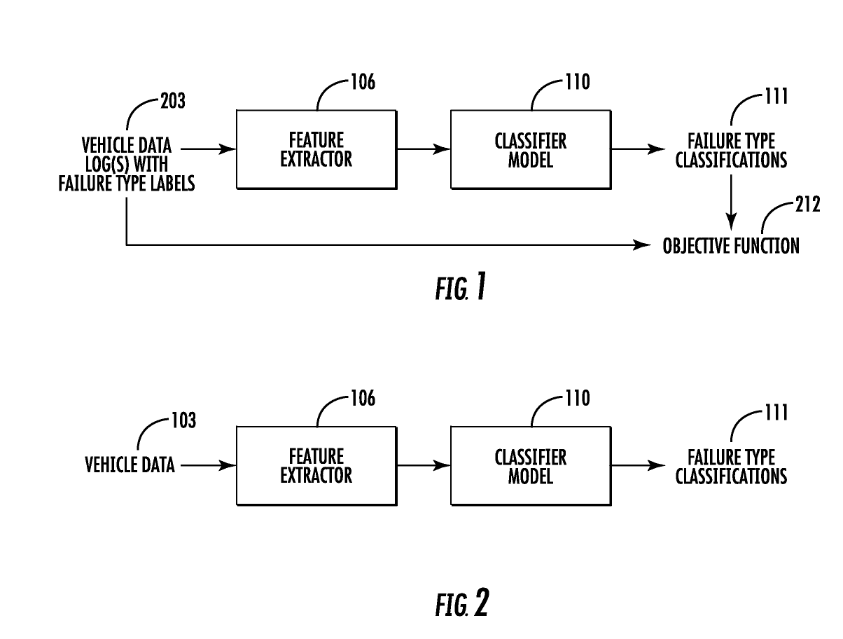

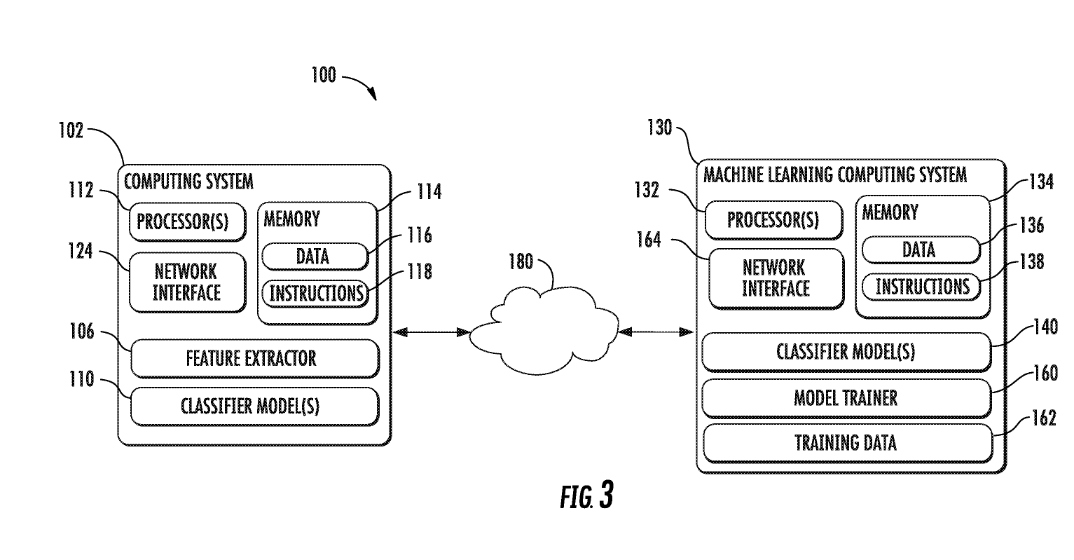

As an example, FIG. 2 depicts a block diagram of an example processing pipeline for failure type classification according to example embodiments of the present disclosure. The example processing pipeline of FIG. 2 includes a feature extractor 106 and a classifier model 110.

The example processing pipeline of FIG. 2 can perform automatic classification of vehicle failure events for an autonomous vehicle based on vehicle data 103 associated with the autonomous vehicle. For example, the vehicle data 103 can be descriptive of vehicle conditions associated with an autonomous vehicle during an autonomous driving session. In some implementations, the vehicle data 103 can include data collected by or otherwise received from various sensors included in the autonomous vehicle. As examples, the vehicle data 103 can include data descriptive of a speed (also referred to as velocity), a steering angle, an acceleration, a braking amount, a vehicle class, operation of an adaptive cruise control system, and/or any other conditions or operating parameters associated with the autonomous vehicle. As further examples, the vehicle data 103 can include various other types of data descriptive of vehicle conditions, including, for example: light detection and ranging data; radio detection and ranging data; imagery collected by one or more cameras onboard the autonomous vehicle; accelerometer data; positioning system data; gyroscope data; throttle position data; engine or crankshaft torque data; exhaust oxygen data; engine air flow data; engine RPM data; vehicle control data associated with a vehicle controller; and/or any other form of vehicle data 103 associated with the vehicle (e.g., collected or produced by sensors or systems onboard the vehicle). As indicated above, the systems and methods of the present disclosure can perform classification of vehicle failure events based on such vehicle data 103.

In some implementations of the present disclosure, the vehicle data 103 can include vehicle data logs from completed driving sessions. For example, an autonomous vehicle or associated computing system can collect and store vehicle data 103 as the autonomous vehicle executes a driving session. After the session has been completed, a log of the vehicle data 103 can be transferred to a computing system that performs classification of vehicle failure events that occurred during the corresponding driving session according to the techniques described herein. As another example, in some implementations of the present disclosure, the vehicle data 103 can be received and analyzed in real-time as the autonomous vehicle operates. For example, in some implementations, the failure classification systems of the present disclosure can be located physically onboard the autonomous vehicle and can receive the vehicle data 103 and classify vehicle failure events in real-time as they occur. As yet another example, in some implementations, the vehicle data 103 can include simulated vehicle data.

The feature extractor 106 can extract a plurality of features from the vehicle data 103. In some implementations, the feature extractor 106 can extract the plurality of features from the vehicle data 103 for each of one or more times at which one or more vehicle failure events respectively occurred. In other implementations, the feature extractor 106 can continuously or near-continuously sample the vehicle data 103 or can sample according to an even or uneven periodicity. In some implementations, each sample of the vehicle data 103 can include a window of data around a particular sampling time.

Regardless, for each instance of sampling of the vehicle data 103 or other classification actions, the feature extractor 106 can extract one or more features from the vehicle data 103. Generally, the features can be of any type that is useful for classifying vehicle failure events. Example features that can be extracted from the vehicle data 103 include the following example features: a valid pose feature indicative of whether a pose of the autonomous vehicle was valid at the time of the vehicle failure event; a cost vendor feature indicative of a vendor of a largest cost associated with a motion plan of the autonomous vehicle at the time of the vehicle failure event; a pre-failure stop reason feature indicative of a first reason that caused the autonomous vehicle to stop prior to the time of the vehicle failure event; a post-failure stop reason feature indicative of a second reason that caused the autonomous vehicle to stop after the time of the vehicle failure event; a failure stop reason indicative of a third reason that caused the autonomous vehicle to stop before and after the time of the vehicle failure event; one or more acceleration features indicative of an acceleration of the autonomous vehicle at one or more times surrounding the time of the vehicle failure event; one or more velocity features indicative of a velocity of the autonomous vehicle at one or more times surrounding the time of the vehicle failure event; a velocity difference feature indicative of a difference in the velocity of the autonomous vehicle before and after the time of the vehicle failure event; a map valid feature indicative of whether a map used by the autonomous vehicle was valid at the time of the vehicle failure event; an unprotected turn distance to stop line feature indicative of a distance to a stop line during an unprotected turn; a wheel angle feature indicative of an angle of one or more wheels of the autonomous vehicle at the time of the vehicle failure event; an odometer difference feature indicative of a distance traveled by the autonomous vehicle after the time of the vehicle failure event; a stopping pose feature indicative of whether a stopping pose of the autonomous vehicle was set at the time of the vehicle failure event; a stopping distance feature indicative of a distance between the autonomous vehicle and the stop line; an adaptive cruise control active feature indicative of whether an adaptive cruise control system of the autonomous vehicle was operating at the time of the vehicle failure event; an adaptive cruise control velocity feature indicative of a velocity of a vehicle tracked by the adaptive cruise control system of the autonomous vehicle at the time of the vehicle failure event; an adaptive cruise control pre-change feature indicative of a number of times the vehicle tracked by the adaptive cruise control system of the autonomous vehicle changed prior to the time of the vehicle failure event; an adaptive cruise control post-change feature indicative of whether the vehicle tracked by the adaptive cruise control system of the autonomous vehicle changed after the time of the vehicle failure event; an adaptive cruise control disappear feature indicative of whether the vehicle tracked by the adaptive cruise control system of the autonomous vehicle disappeared; a stopped feature indicative of whether the autonomous vehicle was stopped at the time of the vehicle failure event; a total cost feature indicative of a total cost associated with the motion plan of the autonomous vehicle at the time of the vehicle failure event; a brake torque feature indicative of a brake torque value of the autonomous vehicle at the time of the vehicle failure event; a left turn signal feature indicative of whether a left turn signal of the autonomous vehicle was illuminated at the time of the vehicle failure event; a right turn signal feature indicative of whether a right turn signal of the autonomous vehicle was illuminated at the time of the vehicle failure event; a rolling back feature indicative of whether the autonomous vehicle was rolling backwards at the time of the vehicle failure event; a juke feature indicative of whether the autonomous vehicle was performing a juke event at the time of the vehicle failure event; a spurious point feature indicative of a number of spurious points associated with the autonomous vehicle at the time of the vehicle failure event; a temperature feature indicative of a temperature at the time of the vehicle failure event; a time of day feature indicative of a time of day at the time of the vehicle failure event; a wiper feature indicative of whether one or more wipers of the autonomous vehicle were operating at the time of the vehicle failure event; a headlight feature indicative of whether one or more headlights of the autonomous vehicle were illuminated at the time of the vehicle failure event; a nearest untrustworthy object feature indicative of a distance to a nearest object designated as untrustworthy; and a weather feature indicative of weather experienced by the autonomous vehicle at the time of the vehicle failure event.

In some implementations, the features can further include notations (e.g., in the form of hashtags, one or more characters, etc.) that were provided by a human passenger of the autonomous vehicle. For example, the notations provided by human passengers can provide a sense or description of what the human passenger experienced during the vehicle failure event (e.g., “#hardbrake”). In other implementations, notations provided by human passengers are not included in the features. The above features are provided as examples only. Many other and different features can be extracted by the feature extractor 106 and used by the classifier model to classify a vehicle failure event.

The features extracted for a particular time sample of the vehicle data 103 (e.g., a time sample that corresponds to a vehicle failure event) can be input into a machine learned classifier model 110 to receive a failure type classification 111 for the corresponding vehicle failure event. For example, the classifier model 110 can receive the features for a given time sample and, in response, provide the failure type classification 111 based on the received features for such time sample or corresponding vehicle failure event. In some implementations, the raw vehicle data 103 can also be provided as inputs to the classifier model 110 in addition to the extracted features. The classification 111 can be a binary classification (e.g., identify a single classification) or a multinomial classification (e.g., provide a relative score or probability for each available classification). Example failure type classifications 111 include: a prediction classification; a perception classification; a motion planning classification; a hardware and firmware classification; a localization classification; an “other” classification; and/or any other types of classification that are desired to be detected. The classification 111 can be used to route the vehicle failure event to the appropriate development team. In some implementations, classifications 111 that are provided with low probability and/or low confidence can be marked as unknown and assessed manually.

As examples, the machine-learned classifier model 110 can be or include one or more of: a random forest classifier; a logistic regression classifier; a support vector machine; one or more decision trees; a neural network; a k-nearest neighbors model; and/or other types of models including both linear models and non-linear models. Neural networks can include deep neural networks, feed-forward neural networks, recurrent neural networks (e.g., long short-term memory recurrent neural networks), convolutional neural networks, or combinations thereof. Various models described above can be boosted using Adaptive Boosting, Gradient Boosting, or other techniques.

FIG. 3 depicts a block diagram of an example computing system 100 according to example embodiments of the present disclosure. The example system 100 includes a computing system 102 and a machine learning computing system 130 that are communicatively coupled over a network 180.

In some implementations, the computing system 102 can perform triaging of vehicle failures. In some implementations, the computing system 102 can be included in an autonomous vehicle. For example, the computing system 102 can be on-board the autonomous vehicle. In other implementations, the computing system 102 is not located on-board the autonomous vehicle. For example, the computing system 102 can operate offline. The computing system 102 can include one or more distinct physical computing devices.

The computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. In some implementations, the computing system 102 can obtain data from one or more memory device(s) that are remote from the system 102.

The memory 114 can also store computer-readable instructions 118 that can be executed by the one or more processors 112. The instructions 118 can be software written in any suitable programming language or can be implemented in hardware. Additionally, or alternatively, the instructions 118 can be executed in logically and/or virtually separate threads on processor(s) 112.

For example, the memory 114 can store instructions 118 that when executed by the one or more processors 112 cause the one or more processors 112 to perform any of the operations and/or functions described herein.

According to an aspect of the present disclosure, the computing system 102 can store or include one or more machine-learned classifier models 110. For example, the classifier models 110 can be or can otherwise include various machine-learned models such as support vector machines, neural networks (e.g., deep neural networks), or other multi-layer non-linear models. Example neural networks include feed-forward neural networks, recurrent neural networks (e.g., long short-term memory recurrent neural networks), or other forms of neural networks.

In some implementations, the computing system 102 can receive the one or more machine-learned models 110 from the machine learning computing system 130 over network 180 and can store the one or more machine-learned models 110 in the memory 114. The computing system 102 can then use or otherwise implement the one or more machine-learned models 110 (e.g., by processor(s) 112).

The machine learning computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage media, such as RAM, ROM, EEPROM, EPROM, one or more memory devices, flash memory devices, etc., and combinations thereof.

The memory 134 can store information that can be accessed by the one or more processors 132. For instance, the memory 134 (e.g., one or more non-transitory computer-readable storage mediums, memory devices) can store data 136 that can be obtained, received, accessed, written, manipulated, created, and/or stored. In some implementations, the machine learning computing system 130 can obtain data from one or more memory device(s) that are remote from the system 130.

The memory 134 can also store computer-readable instructions 138 that can be executed by the one or more processors 132. The instructions 138 can be software written in any suitable programming language or can be implemented in hardware. Additionally, or alternatively, the instructions 138 can be executed in logically and/or virtually separate threads on processor(s) 132.

For example, the memory 134 can store instructions 138 that when executed by the one or more processors 132 cause the one or more processors 132 to perform any of the operations and/or functions described herein.

In some implementations, the machine learning computing system 130 includes one or more server computing devices. If the machine learning computing system 130 includes multiple server computing devices, such server computing devices can operate according to various computing architectures, including, for example, sequential computing architectures, parallel computing architectures, or some combination thereof.

In addition or alternatively to the model(s) 110 at the computing system 102, the machine learning computing system 130 can include one or more machine-learned classifier models 140. For example, the classifier models 140 can be or can otherwise include various machine-learned models such as support vector machines, neural networks (e.g., deep neural networks), or other multi-layer non-linear models. Example neural networks include feed-forward neural networks, recurrent neural networks (e.g., long short-term memory recurrent neural networks), or other forms of neural networks.

As an example, the machine learning computing system 130 can communicate with the computing system 102 according to a client-server relationship. For example, the machine learning computing system 140 can implement the machine-learned models 140 to provide a web service to the computing system 102. For example, the web service can provide an autonomous vehicle triaging service.

Thus, machine-learned models 110 can located and used at the computing system 102 and/or machine-learned models 140 can be located and used at the machine learning computing system 130.

In some implementations, the machine learning computing system 130 and/or the computing system 102 can train the machine-learned models 110 and/or 140 through use of a model trainer 160. The model trainer 160 can train the machine-learned models 110 and/or 140 using one or more training or learning algorithms. One example training technique is backwards propagation of errors. In some implementations, the model trainer 160 can perform supervised training techniques using a set of labeled training data. In other implementations, the model trainer 160 can perform unsupervised training techniques using a set of unlabeled training data. The model trainer 160 can perform a number of generalization techniques to improve the generalization capability of the models being trained. Generalization techniques include weight decays, dropouts, or other techniques.

In particular, the model trainer 160 can train a machine-learned model 110 and/or 140 based on a set of training data 162. The training data 162 can include, for example, the vehicle data logs 203 with event labels and/or other forms of vehicle data 103. The model trainer 160 can be implemented in hardware, firmware, and/or software controlling one or more processors.

The computing system 102 can also include a network interface 124 used to communicate with one or more systems or devices, including systems or devices that are remotely located from the computing system 102. The network interface 124 can include any circuits, components, software, etc. for communicating with one or more networks (e.g., 180). In some implementations, the network interface 124 can include, for example, one or more of a communications controller, receiver, transceiver, transmitter, port, conductors, software and/or hardware for communicating data. Similarly, the machine learning computing system 130 can include a network interface 164.

The network(s) 180 can be any type of network or combination of networks that allows for communication between devices. In some embodiments, the network(s) 180 can include one or more of a local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc.

FIG. 3 illustrates one example computing system 100 that can be used to implement the present disclosure. Other computing systems can be used as well. For example, in some implementations, the computing system 102 can include the model trainer 160 and the training dataset 162. In such implementations, the machine-learned models 110 can be both trained and used locally at the computing system 102. As another example, in some implementations, the computing system 102 is not connected to other computing systems.

In addition, components illustrated and/or discussed as being included in one of the computing systems 102 or 130 can instead be included in another of the computing systems 102 or 130. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Each of the feature extractor 106, a vehicle data simulator, and the model trainer 160 includes computer logic utilized to provide desired functionality. Each of the feature extractor 106, the vehicle data simulator, and the model trainer 160 can be implemented in hardware, firmware, and/or software controlling a general purpose processor. For example, in some implementations, each of the feature extractor 106, the vehicle data simulator, and the model trainer 160 includes program files stored on a storage device, loaded into a memory and executed by one or more processors. In other implementations, each of the feature extractor 106, the vehicle data simulator, and the model trainer 160 includes one or more sets of computer-executable instructions that are stored in a tangible computer-readable storage medium such as RAM hard disk or optical or magnetic media.

### Example Methods

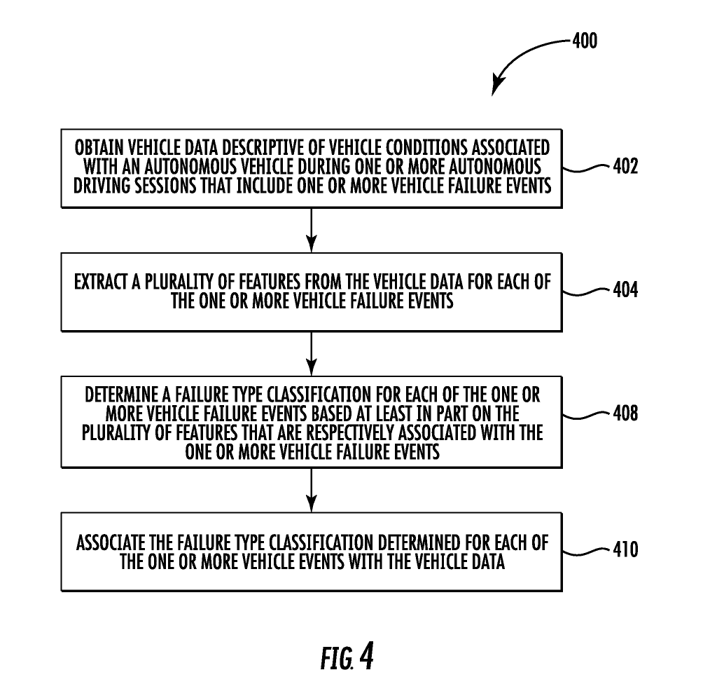

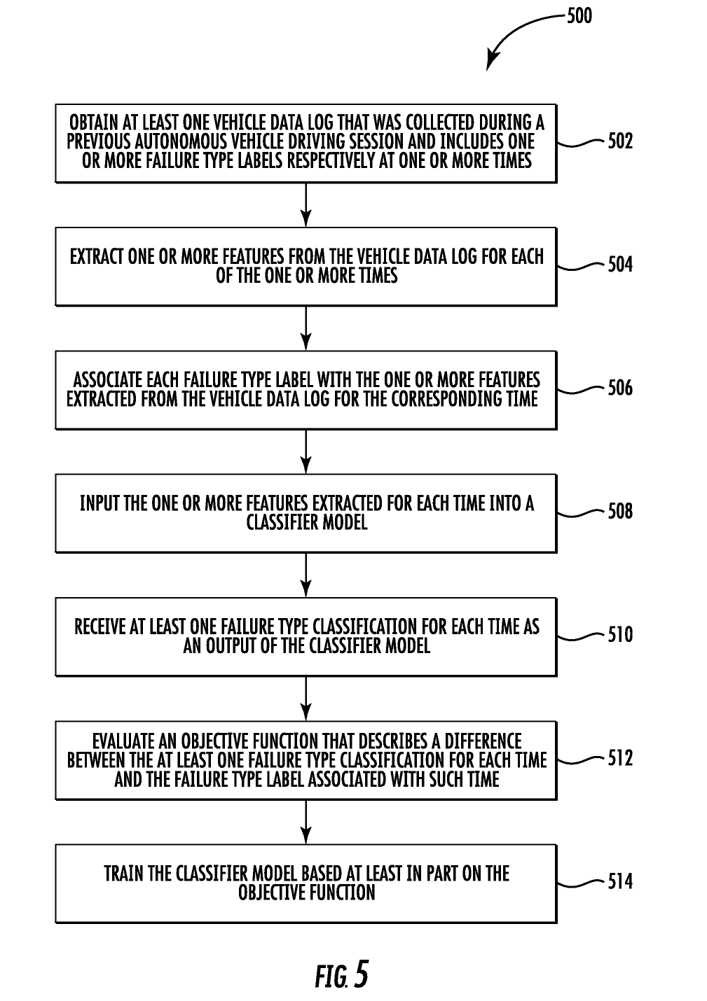

FIG. 4 depicts a flowchart diagram an example method 400 for failure type classification according to example embodiments of the present disclosure.

At 402, a computing system obtains vehicle data descriptive of vehicle conditions associated with an autonomous vehicle during one or more autonomous vehicle driving sessions that include one or more vehicle failure events. As an example, at least one of the one or more vehicle failure events can correspond to an instance in which a human operator was required to assume manual control of the autonomous vehicle.

At 404, the computing system extracts a plurality of features from the vehicle data for each of the one or more vehicle failure events. Generally, the features can be of any type that is useful for classifying vehicle failure events. Example features are described above.

At 408, the computing system determines a failure type classification for each of the one or more vehicle failure events based at least in part on the plurality of features that are respectively associated with the one or more vehicle failure events.

In some implementations, the failure type classification determined for each vehicle failure event specifies which of a plurality of autonomous vehicle control systems was responsible for such vehicle failure event. As examples, in some implementations, determining the failure type classification for each of the one or more vehicle failure events at 406 includes assigning at least one of the failure events to one or more of the following failure type classifications: a prediction classification; a perception classification; a motion planning classification; a hardware and firmware classification; and a localization classification.

In some implementations, at 406, the computing system uses a machine-learned classifier to determine the failure type classification for each of the one or more vehicle failure events. For example, using the machine-learned classifier at 406 can include: inputting the one or more features associated with a vehicle failure event into the machine-learned classifier; and receiving the failure type classification for the vehicle failure event as an output of the machine-learned classifier.

As examples, the machine-learned model can be or include one or more of: a random forest classifier; a logistic regression classifier; a support vector machine; one or more decision trees; a neural network; a k-nearest neighbors model; and/or other types of models including both linear models and non-linear models.

In some implementations, the machine-learned classifier has been trained based at least in part on training data that comprises vehicle data logs that were previously collected during previous autonomous vehicle driving sessions. The previous autonomous vehicle driving sessions can have included one or more previous vehicle failure events. The vehicle data logs can have been annotated with one or more failure type labels that were respectively assigned to the one or more previous vehicle failure events by a human reviewer of the corresponding vehicle data log.

At 410, the computing system associates the failure type classification determined for each of the one or more vehicle failure events with the vehicle data. For example, the failure type classification can be logically associated with the vehicle failure event and routed to a development team associated with the corresponding failure type classification.

In some implementations, the computing system that implements method 400 is located physically on-board the autonomous vehicle and performs method 400 iteratively in real-time as the autonomous vehicle operates to execute the autonomous driving session.

FIG. 5 depicts a flowchart diagram an example method 500 for training a classifier model according to example embodiments of the present disclosure.

At 502, a computing system obtains at least one vehicle data log that was collected during a previous autonomous vehicle driving session and includes one or more failure type labels respectively at one or more times. For example, the one or more times can respectively correspond to times at which one or more vehicle failure events occurred. The one or more failure type labels can have been provided by a human reviewer of the at least one vehicle data log.

As an example, at least one of the one or more vehicle failure events can correspond to an instance in which a human operator was required to assume manual control of the autonomous vehicle. As another example, in some instances, the failure type label for each vehicle failure event can specify which of a plurality of autonomous vehicle control systems was responsible for such vehicle failure event.

At 504, the computing system extracts one or more features from the vehicle data log for each of the one or more times. Generally, the features can be of any type that is useful for classifying vehicle failure events. Example features are described above.

At 506, the computing system associates each failure type label with the one or more features extracted from the vehicle data log for the corresponding time. For example, each failure type label can be logically associated with the corresponding features to generate a training data set.

At 508, the computing system inputs the one or more features extracted for each time into a classifier model. At 510, the computing system receives at least one failure type classification for each time as an output of the classifier model.

At 512, the computing system evaluates an objective function that describes a difference between the at least one failure type classification for each time and the failure type label associated with such time.

At 514, the computing system trains the classifier model based at least in part on the objective function. For example, at 514, the computing system can backpropagate the objective function through the classifier model to train the classifier model.

According to yet further aspects of the present disclosure, in some implementations, the systems and methods described herein can be used to disambiguate vehicle failure events that are isolated to a single autonomous vehicle versus vehicle failure events that are attributable to systems or components that are common across all autonomous vehicles included in a fleet.

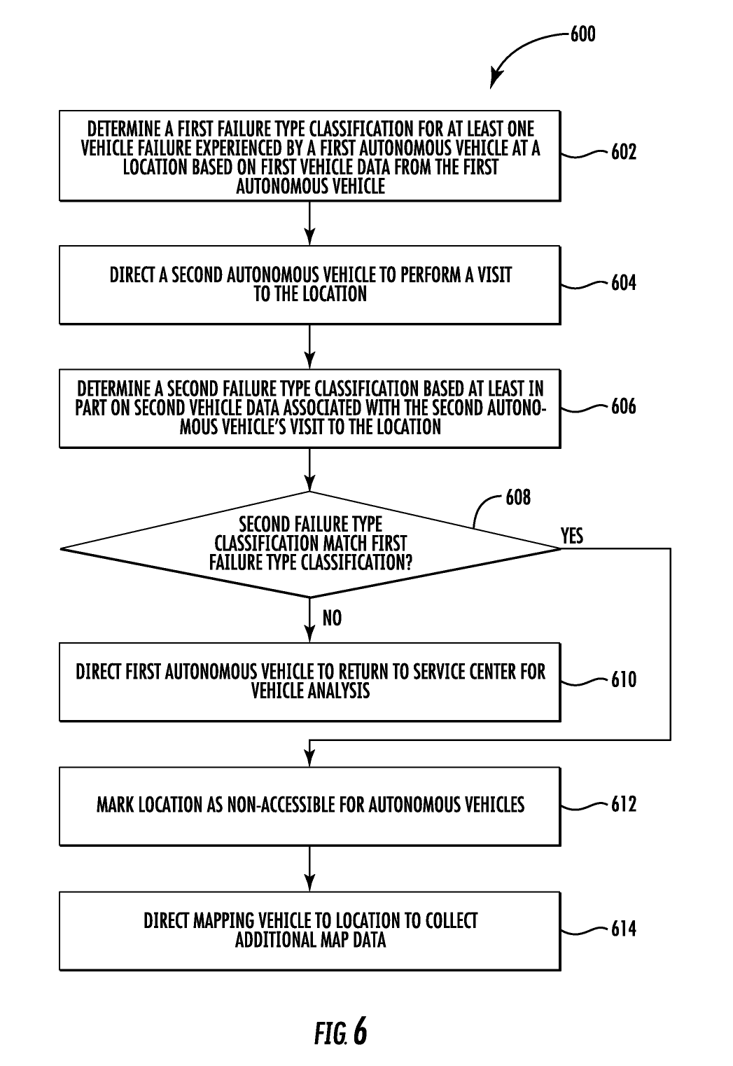

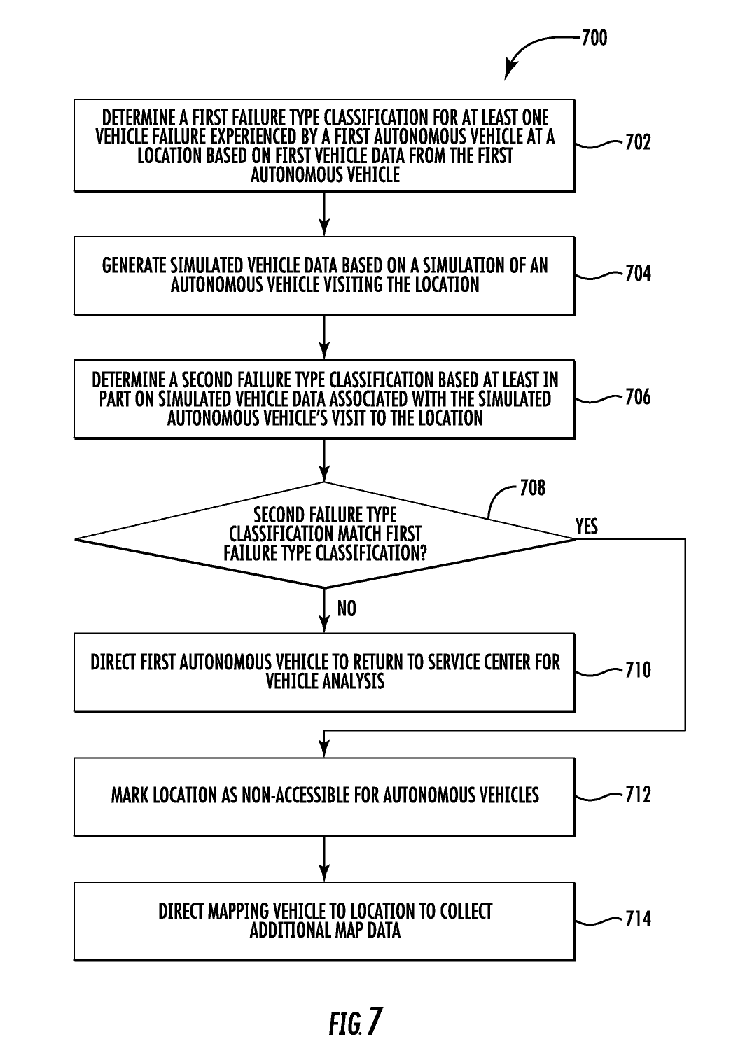

As one example, FIG. 6 depicts a flowchart diagram an example method 600 for disambiguating isolated vehicle failures from whole-fleet failures according to example embodiments of the present disclosure.

At 602, a computing system determines a first failure type classification for at least one vehicle failure experienced by a first autonomous vehicle at a location based on first vehicle data from the first autonomous vehicle. For example, the first vehicle data collected by the first autonomous vehicle at the location can be classified using a machine learned classifier model, as described above.

At 604, the computing system directs a second autonomous vehicle to perform a visit to the location. In particular, the second autonomous vehicle can attempt to recreate a similar driving scenario as to that which resulted in the first vehicle failure event experienced by the first autonomous vehicle (e.g., the second vehicle can follow a same motion path as the first vehicle).

At 606, the computing system determines a second failure type classification based at least in part on second vehicle data associated with the second autonomous vehicle's visit to the location. For example, vehicle data collected by the second autonomous vehicle at the location can be classified using a machine learned classifier model, as described above.

At 608, the computing system determines whether the second failure type classification matches the first failure type classification. If it is determined at 608 that the second failure type classification does not match the first failure type classification, the method 600 proceeds to 610.

At 610, the computing system directs the first autonomous vehicle to return to a service center for vehicle analysis. More particularly, if a different failure type classification is provided for the vehicle data from the second autonomous vehicle relative to the first autonomous vehicle (e.g., the same failure type is not experienced by the second vehicle), then it can be assumed that the issue that led to the first vehicle failure event is isolated to the first autonomous vehicle and, as a result, the first autonomous vehicle can be recalled to a service center for testing and/or maintenance. Other actions can be performed in addition or alternatively to directing the first autonomous vehicle to return to the service center for vehicle analysis.

However, if it determined at 608 that the second failure type classification does match the first failure type classification, then method 600 proceeds to 612.

At 612, the computing system marks the location as non-accessible for autonomous vehicles. At 614, the computing system directs a mapping vehicle to the location to collect additional map data.

More particularly, if the same failure type classification is provided for the vehicle data from the second autonomous vehicle relative to the first autonomous vehicle (e.g., the same failure type is experienced by the second vehicle), then it can be assumed that the issue that led to the first vehicle failure event is not isolated to the first autonomous vehicle and, as a result, the autonomous control system that corresponds to the failure type requires further maintenance across all vehicles in the fleet.

In addition, in some instances, a same failure type by multiple vehicles at the same location can indicate that there is an error in the corresponding map data for such location or insufficient map data for such location. For example, a newly installed stop sign may not be included in the map data. To resolve this issue, for example, the location can temporarily be marked as non-accessible for autonomous vehicles at 612 and a mapping vehicle can be directed to the location to collect additional/updated map data for such location at 614.

FIG. 7 depicts a flowchart diagram an example method 700 for disambiguating isolated vehicle failures from whole-fleet failures according to example embodiments of the present disclosure.

At 702, a computing system determines a first failure type classification for at least one vehicle failure experienced by a first autonomous vehicle at a location based on first vehicle data from the first autonomous vehicle. For example, the first vehicle data collected by the first autonomous vehicle at the location can be classified using a machine learned classifier model, as described above.

At 704, the computing system generates simulated vehicle data based on a simulation of an autonomous vehicle visiting the location. For example, a vehicle data simulator can generate simulated vehicle data for the autonomous vehicle that corresponds to a simulation a portion of a real world autonomous driving session that included the first vehicle failure event.

At 706, the computing system determines a second failure type classification based at least in part on simulated vehicle data associated with the simulated autonomous vehicle's visit to the location. For example, the simulated vehicle data can be classified using the classifier model.

At 708, the computing system determines whether the second failure type classification matches the first failure type classification. If it is determined at 708 that the second failure type classification does not match the first failure type classification, the method 700 proceeds to 710.

At 710, the computing system directs the first autonomous vehicle to return to a service center for vehicle analysis. More particularly, if a different failure type classification is provided for the simulated vehicle data (e.g., the same failure type is not experienced in the simulation), then it can be assumed that the issue that led to the first vehicle failure event is isolated to the first autonomous vehicle and, as a result, the first autonomous vehicle can be recalled to a service center for testing and/or maintenance.

However, if it determined at 708 that the second failure type classification does match the first failure type classification, then method 700 proceeds to 712.

At 712, the computing system marks the location as non-accessible for autonomous vehicles. At 714, the computing system directs a mapping vehicle to the location to collect additional map data.

More particularly, if the same failure type classification is provided for the simulated vehicle data relative to the first autonomous vehicle (e.g., the same failure type is experienced during the simulation), then it can be assumed that the issue that led to the first vehicle failure event is not isolated to the first autonomous vehicle and, as a result, the autonomous control system that corresponds to the failure type requires further maintenance across all vehicles in the fleet.

In addition, in some instances, a same failure type in both real vehicle data and simulated vehicle data can indicate that there is an error in the map data for the corresponding location or insufficient map data for such location. To resolve this issue, for example, the location can temporarily be marked as non-accessible for autonomous vehicles at 712 and a mapping vehicle can be directed to the location to collect additional/updated map data for such location at 714.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

In particular, although FIGS. 4-7 respectively depict steps performed in a particular order for purposes of illustration and discussion, the methods of the present disclosure are not limited to the particularly illustrated order or arrangement. The various steps of the methods 400-700 can be omitted, rearranged, combined, and/or adapted in various ways without deviating from the scope of the present disclosure.

What is claimed is:

1. A computer-implemented method to triage failures experienced by autonomous vehicles, the method comprising:
obtaining, by one or more computing devices, vehicle data descriptive of vehicle conditions associated with an autonomous vehicle during one or more autonomous driving sessions, the one or more autonomous driving sessions including one or more vehicle failure events;
extracting, by the one or more computing devices, a plurality of features from the vehicle data for each of the one or more vehicle failure events;
determining, by the one or more computing devices using a machine-learned classifier, a failure type classification for each of one or more vehicle failure events based at least in part on the plurality of features that are respectively associated with the one or more vehicle failure events; and
associating, by the one or more computing devices, the failure type classification determined for each of the one or more vehicle failure events with the vehicle data.

2. The computer-implemented method of claim 1, wherein at least one of the one or more vehicle failure events comprises an instance in which a human operator was required to assume manual control of the autonomous vehicle.

3. The computer-implemented method of claim 1, wherein the failure type classification determined for each vehicle failure event specifies which of a plurality of autonomous vehicle control systems was responsible for such vehicle failure event.

4. The computer-implemented method of claim 1, wherein the machine-learned classifier has been trained based at least in part on training data that comprises vehicle data logs that were previously collected during previous autonomous vehicle driving sessions, the previous autonomous vehicle driving sessions including one or more previous vehicle failure events, the vehicle data logs annotated with one or more failure type labels that were respectively assigned to the one or more previous vehicle failure events by a human reviewer of the corresponding vehicle data log.

5. The computer-implemented method of claim 1, wherein the plurality of features extracted for each of the one or more vehicle failure events comprise one or more of:
a valid pose feature indicative of whether a pose of the autonomous vehicle was valid at the time of the vehicle failure event;
a cost vendor feature indicative of a vendor of a largest cost associated with a motion plan of the autonomous vehicle at the time of the vehicle failure event;
a pre-failure stop reason feature indicative of a first reason that caused the autonomous vehicle to stop prior to the time of the vehicle failure event;
a post-failure stop reason feature indicative of a second reason that caused the autonomous vehicle to stop after the time of the vehicle failure event;
a failure stop reason indicative of a third reason that caused the autonomous vehicle to stop before and after the time of the vehicle failure event;
one or more acceleration features indicative of an acceleration of the autonomous vehicle at one or more times surrounding the time of the vehicle failure event;
one or more velocity features indicative of a velocity of the autonomous vehicle at one or more times surrounding the time of the vehicle failure event;
a velocity difference feature indicative of a difference in the velocity of the autonomous vehicle before and after the time of the vehicle failure event;
a map valid feature indicative of whether a map used by the autonomous vehicle was valid at the time of the vehicle failure event;
an unprotected turn distance to stop line feature indicative of a distance to a stop line during an unprotected turn;
a wheel angle feature indicative of an angle of one or more wheels of the autonomous vehicle at the time of the vehicle failure event;
an odometer difference feature indicative of a distance traveled by the autonomous vehicle after the time of the vehicle failure event;
a stopping pose feature indicative of whether a stopping pose of the autonomous vehicle was set at the time of the vehicle failure event;
a stopping distance feature indicative of a distance between the autonomous vehicle and the stop line;
an adaptive cruise control active feature indicative of whether an adaptive cruise control system of the autonomous vehicle was operating at the time of the vehicle failure event;
an adaptive cruise control velocity feature indicative of a velocity of a vehicle tracked by the adaptive cruise control system of the autonomous vehicle at the time of the vehicle failure event;
an adaptive cruise control pre-change feature indicative of a number of times the vehicle tracked by the adaptive cruise control system of the autonomous vehicle changed prior to the time of the vehicle failure event;
an adaptive cruise control post-change feature indicative of whether the vehicle tracked by the adaptive cruise control system of the autonomous vehicle changed after the time of the vehicle failure event;
an adaptive cruise control disappear feature indicative of whether the vehicle tracked by the adaptive cruise control system of the autonomous vehicle disappeared;
a stopped feature indicative of whether the autonomous vehicle was stopped at the time of the vehicle failure event;
a total cost feature indicative of a total cost associated with the motion plan of the autonomous vehicle at the time of the vehicle failure event;
a brake torque feature indicative of a brake torque value of the autonomous vehicle at the time of the vehicle failure event;
a left turn signal feature indicative of whether a left turn signal of the autonomous vehicle was illuminated at the time of the vehicle failure event;
a right turn signal feature indicative of whether a right turn signal of the autonomous vehicle was illuminated at the time of the vehicle failure event;
a rolling back feature indicative of whether the autonomous vehicle was rolling backwards at the time of the vehicle failure event;
a juke feature indicative of whether the autonomous vehicle was performing a juke event at the time of the vehicle failure event;
a spurious point feature indicative of a number of spurious points associated with the autonomous vehicle at the time of the vehicle failure event;
a temperature feature indicative of a temperature at the time of the vehicle failure event;
a time of day feature indicative of a time of day at the time of the vehicle failure event;
a wiper feature indicative of whether one or more wipers of the autonomous vehicle were operating at the time of the vehicle failure event;
a headlight feature indicative of whether one or more headlights of the autonomous vehicle were illuminated at the time of the vehicle failure event;
a nearest untrustworthy object feature indicative of a distance to a nearest object designated as untrustworthy; and
a weather feature indicative of weather experienced by the autonomous vehicle at the time of the vehicle failure event.

6. The computer-implemented method of claim 1, wherein determining, by the one or more computing devices using a machine-learned classifier, the failure type classification for each of the one or more vehicle failure events comprises assigning, by the one or more computing devices, at least one of the failure events to one or more of the following failure type classifications:
a prediction classification;
a perception classification;
a motion planning classification;
a hardware and firmware classification; and
a localization classification.

7. The computer-implemented method of claim 1, wherein determining, by the one or more computing devices using the machine-learned classifier, the failure type classification for each of the one or more vehicle failure events comprises, for each vehicle failure event:
inputting, by the one or more computing devices, the one or more features associated with the vehicle failure event into the machine-learned classifier, wherein the machine-learned classifier comprises a machine-learned random forest classifier; and
receiving, by the one or more computing devices, the failure type classification for the vehicle failure event as an output of the machine-learned classifier.

8. The computer-implemented method of claim 1, wherein determining, by the one or more computing devices using the machine-learned classifier, the failure type classification for each of the one or more vehicle failure events comprises, for each vehicle failure event:
inputting, by the one or more computing devices, the one or more features associated with the vehicle failure event into the machine-learned classifier, wherein the machine-learned classifier comprises one or more of a support vector machine, a neural network, a decision tree, a k-nearest neighbors model, and a Gaussian model; and
receiving, by the one or more computing devices, the failure type classification for the vehicle failure event as an output of the machine-learned classifier.

9. The computer-implemented method of claim 1, wherein the one or more computing devices are on-board the autonomous vehicle and the method is iteratively performed in real-time as the autonomous vehicle operates to execute the autonomous driving session.

10. The computer-implemented method of claim 9, wherein:
determining, by the one or more computing devices using the machine-learned classifier, the failure type classification for each of one or more vehicle failure events comprises determining, by the one or more computing devices using the machine-learned classifier, a plurality of potential failure type classifications for each of one or more vehicle failure events;
the method further comprises displaying, by the one or more computing devices, the plurality of potential failure type classifications for each of one or more vehicle failure events for selection by a passenger of the autonomous vehicle.

11. The computer-implemented method of claim 1, further comprising:
directing, by the one or more computing devices, an additional autonomous vehicle to perform a visit to a location associated with at least a first vehicle failure event of the one or more vehicle failure events;
receiving, by the one or more computing devices, additional vehicle data associated with the visit of the additional autonomous vehicle to the location;
extracting, by the one or more computing devices, a plurality of additional features from the additional vehicle data;
determining, by the one or more computing devices using a machine-learned classifier, an additional failure type classification based on the plurality of additional features; and
comparing, by the one or more computing devices, the additional failure type classification to the failure type classification determined for the first vehicle failure event.

12. The computer-implemented method of claim 1, wherein obtaining, by the one or more computing devices, the vehicle data comprises obtaining, by the one or more computing devices, simulated vehicle data descriptive of simulated vehicle conditions associated with the autonomous vehicle during one or more simulated autonomous driving sessions, the one or more simulated autonomous driving sessions including one or more simulated vehicle failure events.

13. The computer-implemented method of claim 1, wherein:
obtaining, by the one or more computing devices, the vehicle data comprises obtaining, by the one or more computing devices, real world vehicle data descriptive of real world vehicle conditions associated with an autonomous vehicle during one or more real world autonomous driving sessions; and
the method further comprises:
generating, by the one or more computing devices, simulated vehicle data for the autonomous vehicle that corresponds to a simulation of at least a portion of the one or more real world autonomous driving sessions that includes at least a first vehicle failure event of the one or more vehicle failure events;
extracting, by the one or more computing devices, a plurality of simulated features from the simulated vehicle data;
determining, by the one or more computing devices using a machine-learned classifier, an additional failure type classification based on the plurality of simulated features; and
comparing, by the one or more computing devices, the additional failure type classification to the failure type classification determined for the first vehicle failure event.

14. A computer system, comprising:
one or more processors; and
one or more tangible, non-transitory, computer-readable media that collectively store:
at least one vehicle data log that was collected during a previous autonomous vehicle driving session, the vehicle data log descriptive of vehicle conditions associated with an autonomous vehicle during the previous autonomous vehicle driving session, the vehicle data log annotated with one or more failure type labels respectively at one or more times that correspond to one or more vehicle failure events, the one or more failure type labels provided by a human reviewer of the at least one vehicle data log; and
instructions that, when executed by the one or more processors, cause the computer system to:
extract, for each of the one or more times, one or more features from the vehicle data log;
associate each failure type label with the one or more features extracted from the vehicle data log for the corresponding time; and
train a classifier model to perform failure type classification based at least in part on the one or more failure type labels and the one or more features respectively associated therewith.

15. The computer system of claim 14, wherein at least one of the one or more vehicle failure events comprises an instance in which a human operator was required to assume manual control of the autonomous vehicle.

16. The computer system of claim 14, wherein the failure type label for each vehicle failure event specifies which of a plurality of autonomous vehicle control systems was responsible for such vehicle failure event.

17. The computer system of claim 14, wherein the classifier model comprises a random forest classifier model.

18. The computer system of claim 14, wherein the classifier model comprises one or more of a support vector machine, a neural network, a decision tree, a k-nearest neighbors model, and a Gaussian model.

19. The computer system of claim 14, wherein to train the classifier model to perform failure type classification based at least in part on the one or more failure type labels and the one or more features respectively associated therewith, the computer system:
inputs, for each of the one or more times, the one or more features extracted for such time into the classifier model;
receives, for each of the one or more times, at least one failure type classification as an output of the classifier model;
evaluates, for each of the one or more times, an objective function that describes a difference between the at least one failure type classification for such time and the failure type label associated with such time; and
trains the classifier model based at least in part on the objective function.

20. A computer system, comprising:
one or more processors;
a machine-learned classifier model; and
one or more tangible, non-transitory, computer-readable media that store instructions that, when executed by the one or more processors, cause the one or more processors perform operations, the operations comprising:
obtaining vehicle data descriptive of vehicle conditions associated with an autonomous vehicle during a driving session;
extracting a plurality of features from the vehicle data;
identifying one or more vehicle failure events;
inputting, for each of the one or more vehicle failure events, the plurality of features into the machine-learned classifier model;
receiving, for each of the one or more vehicle failure events, a failure type classification for the vehicle failure event as an output of the machine-learned classifier model; and
associating the failure type classification provided for each of the one or more vehicle failure events with the vehicle data.
